(19) United States
(12) Patent Application Publication
(10) Pub. No.: US 2020/0161779 A1
(43) Pub. Date: May 21, 2020

(54) Angled plug connector and method of assembly

(71) Applicant: HARTING Electronics GmbH, Espelkamp (DE)

(72) Inventor: Heinrich FRIESEN, Minden (DE)

(73) Assignee: HARTING Electronics GmbH, Espelkamp (DE)

(21) Appl. No.: 16/633,317

(22) PCT Filed: Aug. 13, 2018
(86) PCT No.: PCT/DE2018/100707

§ 371 Date: Jan. 23, 2020

(30) Foreign Application Priority Data
Sep. 1, 2017 (DE) 10 2017 120 180.7

(51) Int. Cl. H01R 4/2433; H01R 13/512; H01R 43/01; H01R 43/20

(52) U.S. Cl. CPC H01R 4/2433; H01R 43/20; H01R 43/01; H01R 13/512

(57) ABSTRACT

A plug connector comprises a plug connector housing, a cutting region arranged in the plug connector housing, and a contact region arranged in the plug connector housing, the contact region being suitable for contacting a mating plug connector. The plug connector comprises a plugging side and a connecting side opposite the plugging side, the plugging side and the connecting side being arranged at an angle to one another. This means that the plug connector is an angled plug connector in which the cutting region and the contact region are arranged on the plugging side. The disclosure further relates to a method for assembling a plug connector of this type.

### TECHNICAL FIELD

The disclosure relates to an angled plug connector a method according to a method for assembling a plug connector.

### BACKGROUND

Plug connectors are needed to reversibly connect electrical lines or connections to one another. Plug connectors and mating plug connectors are used in the prior art to produce an electrical and mechanical connection between two electrical lines or an electrical line and a device or an installation.

DE 20 2006 003 204 U1 discloses a plug connector, which is formed as a plug or an attachment housing. The plug connector comprises a plug connector housing in which an insulating body with electrical contacts is received. The electrical contacts are provided for the connection of electrical lines which lead out of the plug or attachment housing on the rear side of the plug connector.

DE 10 2015 113 786 A1 discloses a plug connector, which is rectangular in form and has a two-part insulating body. This can be mounted in the plug connector housing from two directions.

DE 10 213 107 352 A1 discloses an electrical contact element. This serves for contacting an electrical stranded conductor and, to this end, has a splicing element for separating the individual strands of the stranded conductor.

The use of insulation-displacement connectors for contacting purposes is furthermore known in the prior art.

The known plug connector types are, however, disadvantageous in that not every form of insulating body or plug connector housing can be combined with every type of contact element.

The German Patent and Trademark Office has conducted a search of the following prior art in the priority application pertaining to the present application: DE20012284U1, U.S. Pat. No. 4,431,249A, DE3313284C2, DE102010011614A1, DE202008008809U1, US2012/0100745A1, WO2015/154450A1.

### SUMMARY

The object of the disclosure is to provide an angled plug connector, which is suitable, in particular, for use with stranded conductors. The plug connector should furthermore be economical to produce and easy to handle. The object is achieved by the plug connector and the method as claimed.

The disclosure relates to a plug connector which has a plug connector housing, a cutting region arranged in the plug connector housing and a contact region arranged in the plug connector housing. The contact region is suitable for contacting a mating plug connector. The plug connector furthermore has a mating side and a connection side, opposite the mating side, wherein the mating side and the connection side are arranged or aligned an angle to one another.

“Aligned at an angle to one another” means that the axis of symmetry SA1 of the mating side (S) and the axis of symmetry SA2 of the connection side (A) form an angle α with one another.

An electrical conductor can be inserted into the plug connector from the connection side. According to the invention, the cutting region and the contact region are arranged on the mating side.

The conductor is preferably a multi-core conductor, which contains a plurality of individual conductors/strands.

The plug connector has a plug connector housing. The cutting region and the contact region are arranged in the plug connector housing. The plug connector housing furthermore has a mating side and a connection side. In the case of the known plug connectors, the mating side and the connection side are usually aligned along a line, opposite one another and parallel to one another. In the case of the plug connector according to the invention, the mating side and the connection side are arranged at an angle to one another. The planes of the mating side and the connection side are substantially perpendicular to one another. This has the advantage that the plug connector can also be used in poorly accessible or confined regions.

The contact region and the cutting region are arranged on the mating side of the plug connector housing. The mating side serves for contacting a mating plug connector and the connection side serves for the connection of a conductor. The connection of a conductor takes place from the connection side in the direction of the mating side. The connection side is therefore configured such that the conductor can be inserted without difficulty.

Ideally, the connection side has a cable gland for securely fastening the conductor. The cable gland has the advantage that active tensile forces and stresses are kept away from the plug connector and the durability of the plug connection is therefore increased.

In a preferred configuration, the mating side and the connection side are arranged at an angle to one another of less than 180°, preferably less than 135°, in particular less than or equal to 90°. With an angle of less than 180°, only a plug connector with individually produced contacts, for instance angled rotary contacts, has hitherto been possible. However, these are expensive to produce and very difficult to assemble. The plug connector according to the invention, on the other hand, enables unobstructed assembly despite the mutually angled arrangement. An angle of less than or equal to 90° is the variant which saves the most space in or on a device, since the plug connector housing in this configuration is shown to be the smallest in terms of the length and the width of the plug connector as a whole.

In an advantageous configuration, the mating side is in at least two parts, wherein the cutting region forms a first section and the contact region forms a second section. As a result of the two-part configuration of the mating side, the conductor inserted through the connection side is contacted more easily. The contacting of the received conductor takes place by plugging the cutting region and contact region together. This has the advantage that it is easier for a user to handle and assemble the plug connector and this is therefore possible without a tool.

The mating side preferably has the contact region at the end remote from the connection side, wherein the contact region merges into at least one contact element at the far end of the remote end. The transition into at least one contact element enables contacting of the plug connector by means of at least one mating plug connector. The contact element can be both a pin contact and a socket contact.

The cutting region is arranged on that end of the mating side which faces the connection side. The cutting region and contact region are therefore advantageously opposite one another and can be plugged together easily by a user.

In a preferred configuration, the cutting region has a conductor receptacle. This serves for receiving the conductor, which leads from the connection side to the mating side. The conductor receptacle secures the conductor on the mating side.

In a particularly preferred configuration, the conductor receptacle has at least one conductor holder, wherein the conductor holder serves for securing the conductor. The conductor holder is an approximately u-shaped contour, in particular the holding side of an insulation-displacement connector, in which the conductor to be cut is held. The conductor is placed in the conductor holder and fastened therein in a secure and fixed manner.

The contact region advantageously has at least one blade, in particular an insulation-displacement connector. The blade is the counter-piece to the conductor holder of the cutting region. In contrast to the conductor holder, however, the blade is formed with a sharp edge so that insulation, more precisely a sheath, of the conductor can be cut without difficulty. In this case, the action of the blade is not powerful enough to damage any strands within the conductor.

In a preferred configuration, the blade and the conductor holder can be plugged together. As a result of this combination, the plug connector can be assembled without a tool or other aid.

In this case, it is particularly advantageous that the conductor can be contacted as a result of the connection between the cutting region and the contact region, thereby enabling the transmission of power or the like. The combination of the connection side, the cutting region, the contact region and the transition to the contact element enable reliable transmission from a plug connector to a mating plug connector.

In a preferred configuration of the invention, the plug connector has at least one seal in order to protect it from external environmental influences. Ideally, a seal is arranged on the connection side, in the region of the cable gland. A further seal could be arranged on the mating side, at the transmission to the actual plug connector housing. The plug connector is therefore optimally protected.

The invention furthermore relates to a method for assembling a plug connector, which comprises the following steps:
a) inserting a conductor into the plug connector housing via the connection side and through the angle between the mating side and the connection side,
b) placing and fastening the conductor in the conductor holder in the cutting region of the mating region,
c) adapting the length of the conductor to the cutting region and shortening it as required,
d) attaching the contact region to the cutting region, whereby the insulation of the conductor is cut and the conductor is therefore contacted.

By using the plug connector in combination with the disclosed method, it is possible to provide an angled, field-assemblable plug connector, which can be assembled simply and straightforwardly by a user.

### BRIEF DESCRIPTION OF THE DRAWINGS

An exemplary embodiment of the invention is illustrated in the drawings and will be explained in more detail below.

FIG. 1 is a side view of a plug connector.

FIG. 2 is a perspective illustration of a cutting region.

FIG. 3 is a perspective illustration of a contact region.

FIG. 4 is an illustration of the method steps for assembly of a plug connector.

### DETAILED DESCRIPTION

The figures contain partially simplified, schematic illustrations. Identical reference signs are sometimes used for elements which are similar, but possibly not identical. Different views of similar elements could be drawn to different scales.

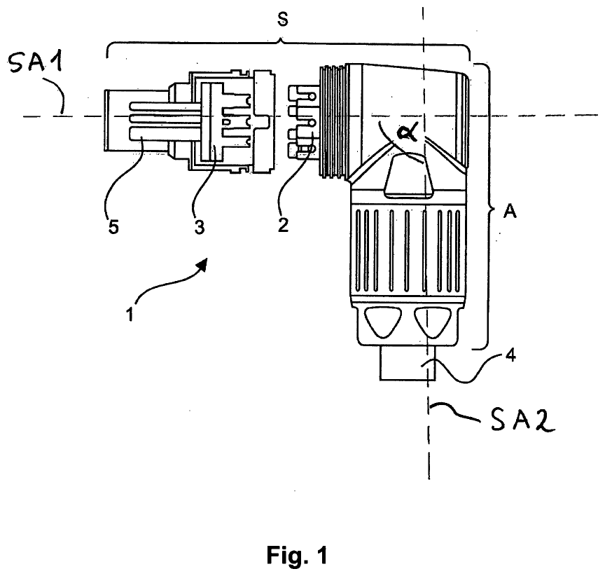

FIG. 1 shows a side view of a plug connector 1. In particular, this is a circular plug connector, more precisely an angled circular plug connector. In FIG. 1, the plug connector 1 is illustrated with its two-part plug connector housing in this exemplary embodiment. In this case, the plug connector housing has connection side A and a mating side S. The connection side A and the mating side S are arranged at a 90° angle, i.e. at a right angle, to one another.

In the manner described, the mating side comprises a first section and a second section, which can be screwed together. Alternatively, the connection between the two sections of the mating side S can also be realized by a plug connection or a bayonet connection.

The cutting region 2, the contact region 3, the conductor 4 and the contact element 5 are received in the plug connector housing. In this case, the conductor 4 is received on the connection side A. The cutting region 2 is located in the first section of the mating side S. The contact region 3 and, adjoining this, the at least one contact element 5 are received in the second section of the mating side S. The whole mating side S is received in the plug connector housing, which is shown partially transparently for better clarity.

The conductor 4 is a cable, which comprises a plurality of individual insulated strands. The conductor 4 is inserted into the plug connector housing in the direction of the 90° angle from one side of the connection side A. The fastening and strain relief are realized by a cable fastener or cable gland known from the prior art, which ideally also has a corresponding seal for protection against external environmental influences.

The mating side S only adjoins the connection side A in the direction rotated through 90°. In this case, the mating side S adjoins the side of the connection side A which is opposite the cable fastener. In FIG. 1, at this point, the first section of the mating side S, the cutting region 2, is already inserted into the plug connector housing and the individual strands of the conductor 4 are already integrated.

The cutting region 2 has eight conductor receptacles 6, each having a conductor holder 7. Analogously, the contact region 3 has eight blades 8, which cooperate with the conductor receptacles 6. The blades 8 and the conductor receptacles 6 are arranged approximately circularly in this case, so that a closed circle, more precisely a polygon, can be seen in plan view.

To achieve optimal cutting of the insulation, more precisely the sheath, of the individual strands, the conductor receptacles 6 and the blades 8 are arranged offset from one another. This means that they are either positioned at any angle to one another or they are arranged at slightly different radii, as shown in FIG. 1.

The contact element 5 is integrated in the contact region 3 in certain regions and is securely held therein. In FIG. 1, eight contact elements 5 are integrated in the contact region 3. However, these are not fully visible in FIG. 1 owing to the side view, although they are shown in more detail in FIG. 3.

The combination of the blade 8 and the conductor receptacle 6, or conductor holder 7, as realized following the assembly of the connection side A and mating side S, constitutes the application of insulation-displacement connector technology.

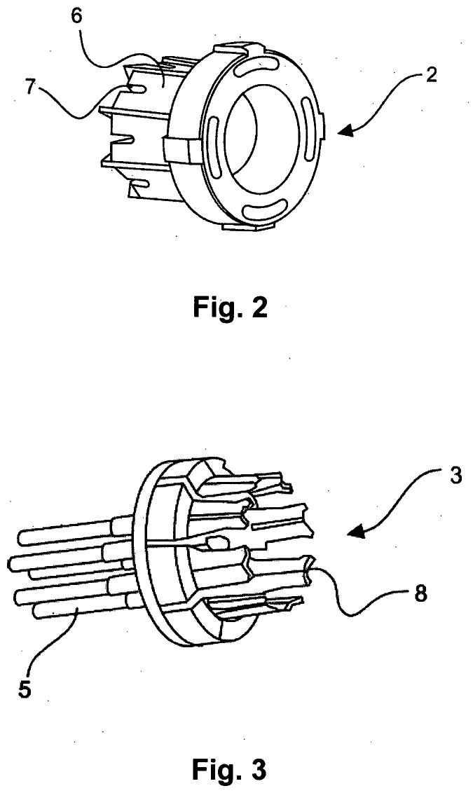

FIG. 2 shows the cutting region 2. This has a circular form and, in this example, has four molded portions in order to be received in a torsion-resistant manner in the first section of the mating side S. In this case, the first section (not illustrated separately) has corresponding recesses into which the molded portions dip and therefore fasten the cutting region 2 securely.

Eight conductor receptacles 6 are furthermore integrally molded on the cutting region 2, which each have a conductor holder 7. In this case, the conductor receptacles 6 are arranged circularly so that a closed circle, more precisely a polygon, is formed in plan view.

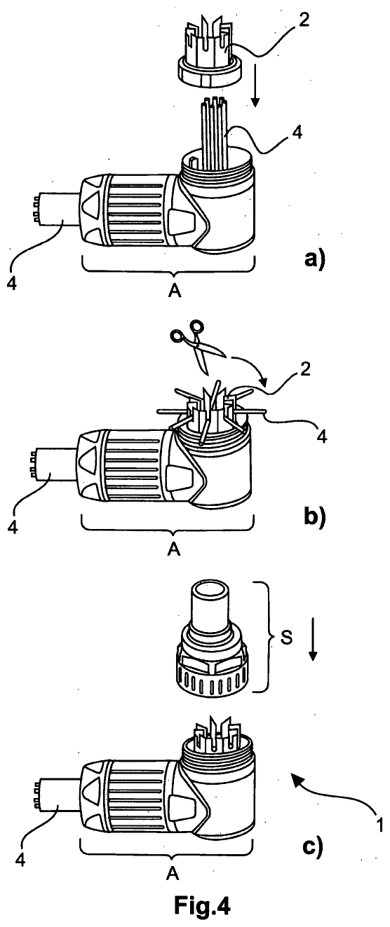

The conductor holders 7 are notches in the conductor receptacles 6, which are formed to be large enough to neither damage nor destroy the sheath of a received strand. However, they are furthermore designed to also be narrow enough for a received strand, as shown in FIG. 4 b), to be held securely. The conductor holder 7 in this case is approximately u-shaped.

FIG. 3 shows the contact region 3. This has a circular form and, in this example, has a recess in order to be received in a torsion-resistant manner in the second section of the mating side S. In this case, the second section (not illustrated separately here) accordingly has a molded portion into which the recess can dip and can therefore fasten the contact region 3 securely.

Eight blades 8 are integrally formed on the contact region 3 in the direction of the cutting region 2. In this case, a blade 8 comprises two mutually oppositely arranged sharp-edged elements, wherein the sharp sides are aligned towards one another so that they cut an objected inserted between them from two sides.

Eight contact elements 5 are arranged on the side remote from the cutting region 2. In this case, one contact element 5 is securely and fixedly connected to one blade 8 in each case. The connection can be realized by screwing, soldering, plugging, latching or the like. In FIG. 3, the contact element 5 is formed as a pin contact, wherein an embodiment as a socket contact is also conceivable.

FIG. 4 shows the fundamental steps of the method according to the invention. In FIG. 4 a), a conductor 4 is inserted into the plug connector housing through the connection side A in the direction of the mating side S. In this case, the outermost insulation of the conductor 4 as a whole in the region within the plug connector housing has been removed so that only the strands of the conductor 4 which are still received therein have their insulation. This corresponds to method step a).

The cutting region 2 is then attached. This is slipped over the individual strands and subsequently latched at the connection side A.

The method step b) and the step c) are then shown in FIG. 4 b). The strands are placed in the conductor holders 7 and are thereby fastened therein. The adaptation of the length of the individual strands then takes place, in this case illustrated by the scissors symbol. The shortening of the strands enables them to be received neatly in the plug connector housing and facilitates the attachment of the contact region 3.

The attachment of the contact region 3 is shown in FIG. 4 c), wherein the contact region is received in the second part of the mating side S here and is therefore not visible. In this step, the insulation of the individual strands is cut and the contact between the contact element 5 and the conductor 4, more precisely a strand, is therefore generated.

Following the attachment, the connection between the mating side S and the connection side A is fastened, in this case by screwing.

Even though various aspects or features of the invention are each shown combined in the figures, it is clear to the person skilled in the art that—unless stated otherwise—the combinations illustrated and discussed are not the sole options. In particular, mutually corresponding entities or feature complexes of different exemplary embodiments can be replaced with one another.

### LIST OF REFERENCE SIGNS

1 Plug connector
2 Cutting region
3 Contact region
4 Conductor
5 Contact element
6 Conductor receptacle
7 Conductor holder
8 Blade
A Connection side
S Mating side
α Angle

1.-14. (canceled)

15. A plug connector, comprising:
a plug connector housing,
a cutting region arranged in the plug connector housing; and
a contact region arranged in the plug connector housing,
wherein the contact region is suitable for contacting a mating plug connector,
wherein the plug connector has a mating side and a connection side,
wherein an electrical conductor can be inserted into the plug connector from the connection side,
wherein the mating side and the connection side are arranged at an angle to one another, and
wherein the mating side and the connection side are arranged at an angle to one another of less than 180°.

16. The plug connector as in claim 15,
wherein the mating side and the connection side are arranged at an angle to one another of less than 135°.

17. The plug connector as in claim 15,
wherein the mating side and the connection side are arranged at an angle to one another of less than or equal to 90°.

18. The plug connector as in claim 15,
wherein the contact region has at least one blade.

19. The plug connector as in claim 15,
wherein the contact region has at least one insulation-displacement connector.

20. The plug connector as in claim 15,
wherein the mating side is in at least two parts, and
wherein the cutting region forms a first section and the contact region forms a second section.

21. The plug connector as in claim 15,
wherein the mating side has the contact region at an end remote from the connection side,
wherein the contact region merges into at least one contact element at a far end of the remote end.

22. The plug connector as in claim 15,
wherein the mating side has the cutting region at an end facing the connection side.

23. The plug connector as in claim 15,
wherein the cutting region has a conductor receptacle.

24. The plug connector as in claim 23,
wherein the conductor receptacle has at least one conductor holder,
wherein the conductor holder serves for fastening a conductor.

25. The plug connector as in claim 24,
wherein the contact region has at least one blade and
wherein the blade and the conductor holder can be plugged together.

26. The plug connector as in claim 23,
wherein the electrical conductor can be contacted as a result of a connection of the cutting region and the conductor receptacle.

27. The plug connector as in claim 15,
wherein the electrical conductor can be received in the plug connector housing through the connection side via the cutting region and the contact region.

28. The plug connector as in claim 15,
wherein the plug connector has at least one seal.

29. A method for assembling a plug connector, comprising the following steps:
providing the plug connector as in claim 24;
inserting a conductor into the plug connector housing via the connection side and through the angle between the mating side and the connection side;
placing and fastening the conductor in the conductor holder in the cutting region of the mating side;
adapting a length of the conductor to the cutting region and shortening it as required; and
attaching the contact region to the cutting region, whereby an insulation of the conductor is cut and the conductor is therefore contacted.
